(19) United States
(12) Patent Application Publication
(10) Pub. No.: US 2016/0092718 A1
(43) Pub. Date: Mar. 31, 2016

(54) FINGERPRINT SENSOR

(71) Applicants: Eric Dean Jensen, Irvine, CA (US); William R. Crumly, Anaheim, CA (US)

(72) Inventors: Eric Dean Jensen, Irvine, CA (US); William R. Crumly, Anaheim, CA (US)

(21) Appl. No.: 14/801,725

(22) Filed: Jul. 16, 2015

Related U.S. Application Data
(60) Provisional application No. 62/025,098, filed on Jul. 16, 2014.

(51) Int. Cl. G06K 9/00

(52) U.S. Cl. CPC G06K 9/00013

(57) ABSTRACT

An improvement to the optical performance of a digital fingerprint scanner is disclosed. The invention evens out the illumination while reducing unwanted artifacts. This results in a “clean” image with an improved S/N ratio, the purity of the captured image offers the ancillary benefit of lowering the overall power requirements of the system while having direct positive impacts on improving accuracy and speed in the fingerprint recognition.

### BACKGROUND OF THE INVENTION

Problem Solved: The image output of a specific type of optical digital fingerprint scanner has poor quality because the image includes significantly non-uniform illumination that obscures the fingerprint. The illumination non-uniformity reduces the signal-to-noise ratio of the data, thereby reducing the ability of the reader system to properly identify the fingerprint.

For the specific type of fingerprint reader to which this invention applies, the alternate lighting concepts were partially successful in reducing the non-uniformity of the lighting, but dramatically increased the intensity of the remaining problem areas, so the net effect was minimal. The DSP efforts were partially successful in evening out the illumination patterns without increasing the intensity of the extraneous lighting, but at the expense of reducing the contrast of the important parts of the fingerprint and introducing new artifacts.

The invention evens out the illumination while reducing unwanted artifacts. This results in a “clean” image with an improved S/N ratio. The purity of the captured image offers the ancillary benefit of lowering the overall power requirements of the system while having direct positive impacts on improving accuracy and speed in the fingerprint recognition.

### BRIEF DESCRIPTION OF THE DRAWINGS

FIG. 1 shows version of the present invention.

FIG. 2 is a reproduction of FIG. 6 shown in U.S. Pat. No. 8,204,284 to Wu.

FIG. 3 shows pictures of the light distribution of an original minimal configuration sensor with two light sources.

FIG. 4 shows pictures of the light distribution with a diffusion plate between the LEDs and the sensor.

FIG. 5 shows pictures of the light distribution with a diffusion plate and multiple light sources.

FIG. 6 shows pictures of the light distribution of a sensor with two base plates being used.

FIG. 7 shows pictures of the light distribution of a sensor with a 3^{rd} diffusion film on the top surface of the press plate.

FIG. 8A shows image captured by the camera when imaging only the clear window.

FIG. 8B shows image captured by the camera with the press plate in place and a finger pressed against the press plate.

FIG. 9 shows a diagram of a ray of light moving from one medium to another.

FIG. 10 shows a diagram of an intermediate coating between the air and glass and the reflection loss.

FIG. 11A shows the reflected image captured by the camera from an untreated window.

FIG. 11B shows the image captured by the camera of a window with a commercial AR coating applied to both sides of the window.

FIG. 12 shows an Excel spreadsheet showing an estimate of the effect that AR coatings on different surfaces of the structure will have on the signal to noise ratio.

FIG. 13A shows the image captured by the camera of the bottom of the press plate with the original window.

FIG. 13B shows the image captured by the camera of the bottom of the press plate using a window with an AR coating on both sides.

FIG. 14 shows a cut-away view of an example assembly with the window placed just below the thin press plate.

### DESCRIPTION OF THE INVENTION

As stated above, the image output of a specific type of optical digital fingerprint scanner has poor quality because the image includes significantly non-uniform illumination that obscures the fingerprint. The illumination non-uniformity reduces the signal-to-noise ratio of the data, thereby reducing the ability of the reader system to properly identify the fingerprint. The invention claimed here solves this problem.

The invention eliminates nearly all of the illumination non-uniformity in the captured image. The invention is “analog” in nature and does not rely on digital signal processing.

This invention is an improvement on what currently exists. For the specific type of fingerprint reader for which this invention applies, the attempts to solve the problem have included various lighting methods and digital signal processing algorithms. The new solution uses neither concept. The other methods showed only incremental improvements. The new method cleans up the image nearly optimally.

In both known prior attempts to solve this problem, side-effects of the solution attempts negated any advantage of the concept. The S/N ratio was reduced and the accuracy of the system was not improved. At the root of the failures is the highly deceptive nature of the problem. The original research teams were unable to solve the problem because they were not able to fully understand the system.

The invention evens out the illumination while reducing unwanted artifacts. This results in a “clean” image with an improved S/N ratio. The purity of the captured image offers the ancillary benefit of lowering the overall power requirements of the system while having direct positive impacts on improving accuracy and speed in the fingerprint recognition.

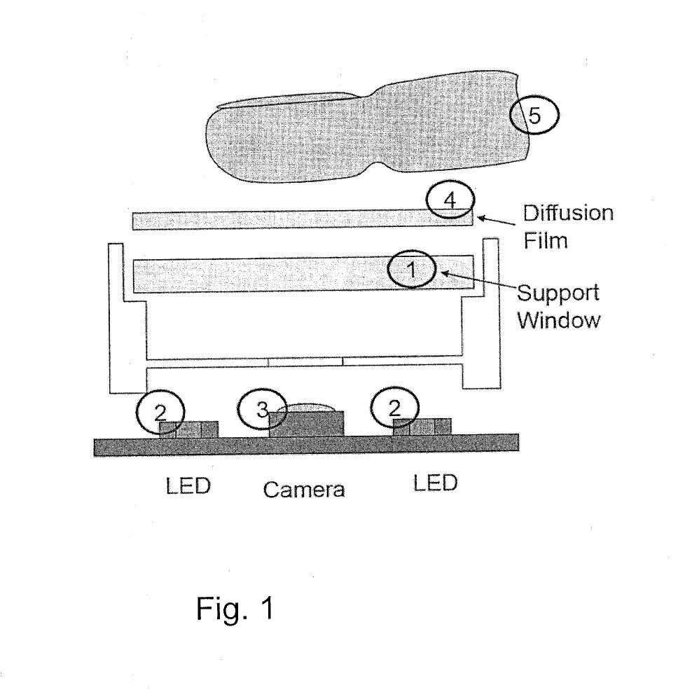

The version of the invention, shown in FIG. 1, discussed here includes:
1. Support Window
2. Light Source
3. Camera
4. Diffusion Film
5. Finger

### Relationship Between the Components:

Light is emitted from the light sources [2]. The light interacts with the support window [1], diffusion film [4], and finger [5]. An image is captured by the camera [3]. The camera [3] does not capture an image of the finger [5] directly. The finger [5] is obscured from view behind the diffusion film [4]. The full description of the image creation requires an understanding of the function of TIR (total internal reflection) using indirect lighting and compression effects within the diffusion film [4]. A fairly representative description of the phenomenon is that the camera [3] captures an image of the “shadow” of the fingerprint (not the whole finger). For 2+ years, teams of scientists in Asia, Europe and the US attempted to solve this problem by adding, moving, redirecting, and affecting the light sources—or by post-processing the image. All that work failed. We discovered the problem could be solved more effectively by modifying the support window [1] and the diffusion film [2].

### How the Invention Works:

Light is emitted in a spherical pattern from the light sources [2]. Some of the light is scattered at shallow angles into the film as it passes through the diffusion layer [4] and is subject to TIR effects as it interacts with the finger [5] at the top surface of the diffusion film [4]. The changes in reflection and absorption near and far from the fingerprint ridges create an image on the bottom of the film that is a replica of the fingerprint and can be readily captured by the camera [3]. If the light is perfectly uniform, the resulting “shadow” represents the purest “signal” of the fingerprint that the system is capable of producing. Any non-uniformities of the illumination reduce the signal/noise ratio of the image. These variations can be seen both in observations of the sensor when activated, and in the images created by the sensor in application. Great efforts are made in the design and improvements of the system to cast light from the light sources [2] in a more uniform pattern to eliminate highlights and artifacts. Additional light from the light sources [2] is reflected off the support window [1], diffusion film [4], and finger [5]. These secondary reflections originally were considered to be negligible by the previous research teams. We discovered these secondary, direct and indirect reflections of light bouncing back toward the camera from both the top and bottom surfaces of the support window [1] and of the diffusion film [4] are substantial, and by reducing the reflections directed to the camera [3] through application of anti-reflection coatings optimizing the reflecting angles, the image artifacts and non-uniformity of the shadow image captured by the camera [3] is preserved, and the artifacts and highlights are nearly eliminated.

### How to Make the Invention:

Apply AR coatings to the surfaces of the diffusion film and the support window. Several acceptable methods exist commercially. We have successfully implemented the solution using vapor-deposition, condensation, and application of AR coated films.

It is not necessary to apply the AR treatment to all applicable surfaces in order to achieve a performance improvement. Coating any single surface will create a measurable improvement. The best results are achieved when all horizontal surfaces of the support window [1] and diffusion film [4] are treated.

Thinking broadly about the system, there would be an advantage to combining the diffusion film and the support window into one piece to save costs in the final assembly. The thinness of the layers (especially layers within the diffusion film) is critical. The technologies used to fabricate DVD's and Blu-Ray discs, for example, are capable of compositing polycarbonate materials and various light modification materials in thin layers. Those processes may be capable of combining: the support window and the diffusion film into one monolithic piece. If that were done, it may change the nature of the AR coating on the top of the support window and bottom surface of the diffusion film. Combining the diffusion film and the support window will not eliminate the need for the reflections to be managed at those interfaces. It is likely that AR coatings or transitional refractive index materials would be at the interface. To that extent, because of the need to manage reflections in the diffusion and other layers of the composite, the possible combination of the diffusion film and the support window would still be subject to this invention.

Another systematic option would be to bring the support window closer to the camera, or increase the thickness of the support window toward the camera so that the bottom surface of the support window is close or contacting the camera. Also, the shape of the bottom surface of the support window could be altered. In both cases, the angles of the reflected light and fingerprint image change with respect to camera. It may be possible to reduce the effects of reflections from the bottom surface of the support window through careful geometry. However, the reflections from the top surface and diffusion film and transitions within remain important and will require AR treatment for optimal performance.

### How to Use the Invention:

Apply the AR coatings to any of the following surfaces. Bottom of the support window, top of the support window, bottom of the diffusion film, top of the diffusion film.

Fingerprints have been found on ancient Babylonian clay tablets, seals, and pottery. They have also been found on the walls of Egyptian tombs and on Minoan, Greek, and Chinese pottery, as well as on bricks and tiles from ancient Babylon and Rome. Some of these fingerprints were deposited unintentionally by the potters and masons as a natural consequence of their work, and others were made in the process of adding decoration. However, on some pottery, fingerprints have been impressed so deeply into the clay that they were possibly intended to serve as an identifying mark by the maker.

Fingerprints were used as signatures in ancient Babylon in the second millennium BCE. In order to protect against forgery, parties to a legal contract would impress their fingerprints into a clay tablet on which the contract had been written. By 246 BCE, Chinese officials were impressing their fingerprints into the clay seals used to seal documents. With the advent of silk and paper in China, parties to a legal contract impressed their handprints on the document. Sometime before 851 CE, an Arab merchant in China, Abu Zayd Hasan, witnessed Chinese merchants using fingerprints to authenticate loans. By 702, Japan had adopted the Chinese practice of sealing contracts with fingerprints.

Fingerprint Sensors

A fingerprint sensor is an electronic device used to capture a digital image of the fingerprint pattern. The captured image is called a live scan. This live scan is digitally processed to create a biometric template (a collection of extracted features) which is stored and used for matching. This is an overview of some of the more commonly used fingerprint sensor technologies.

Optical fingerprint imaging involves capturing a digital image of the print using visible light. This type of sensor is, in essence, a specialized digital camera. The top layer of the sensor, where the finger is placed, is known as the touch surface. Beneath this layer is a light-emitting phosphor layer which illuminates the surface of the finger. The light reflected from the finger passes to an array of solid state pixels (a charge-coupled device) which captures a visual image of the fingerprint

Fingerprint image acquisition is considered to be the most critical step in an automated fingerprint authentication system, as it determines the final fingerprint image quality, which has a drastic effect on the overall system performance. There are different types of fingerprint readers on the market, but the basic idea behind each is to measure the physical difference between ridges and valleys.

The procedure for capturing a fingerprint using a sensor consists of rolling or touching with the finger onto a sensing area, which according to the physical principle in use (in this case, optical) captures the difference between valleys and ridges. When a finger touches or rolls onto a surface, the elastic skin deforms. The quantity and direction of the pressure applied by the user, the skin conditions and the projection of an irregular 3D object (the finger) onto a 2D flat plane introduce distortions, noise and inconsistencies in the captured fingerprint image. These problems result in inconsistent, irreproducible and non-uniform irregularities in the image. During each acquisition, therefore, the results of the imaging are different and uncontrollable. The representation of the same fingerprint changes every time the finger is placed on the sensor plate, increasing the complexity of any attempt to match fingerprints, impairing the system performance and consequently, limiting the widespread use of this biometric technology. It is important that the image acquired be as clear and accurate as possible. One way of increasing the difference in the optical signal between the ridges and the valleys is to use frustrated total internal reflection to increase the contrast in the image between the ridges and valleys of the fingerprint.

Total internal reflection is an optical phenomenon that happens when a ray of light strikes a medium boundary at an angle larger than a particular critical angle with respect to the normal to the surface. If the refractive index is lower on the other side of the boundary and the incident angle is greater than the critical angle, no light can pass through and all of the light is reflected. The critical angle is the angle of incidence above which the total internal reflection occurs.

When a light beam crosses a boundary between materials with different kinds of refractive indices, the light beam will be partially refracted at the boundary surface, and partially reflected. However, if the angle of incidence is greater (i.e. the ray is closer to being parallel to the boundary) than the critical angle—the angle of incidence at which light is refracted such that it travels along the boundary—then the light will stop crossing the boundary altogether and instead be totally reflected back internally. This can only occur where light travels from a medium with a higher [n₁=higher refractive index] to one with a lower refractive index [n₂=lower refractive index]. For example, it will occur when passing from glass to air, but not when passing from air to glass.

The critical angle is the angle of incidence above which total internal reflection occurs. The angle of incidence is measured with respect to the normal at the refractive boundary. Consider a light ray passing from glass into air. The light emanating from the interface is bent towards the glass. When the incident angle is increased sufficiently, the transmitted angle (in air) reaches 90 degrees. It is at this point no light is transmitted into air. The critical angle θ_{cis} given by Snell's law,

n₁ sin θᵢ=n₂ sin θₜ

Rearranging Snell's Law, we get incidence

$$sin {θ}_{i} = \frac{{n}_{2}}{{n}_{1}} sin {θ}_{t} .$$

To find the critical angle, we find the value for θᵢ when θₜ=90° and thus sin θₜ=1. The resulting value of θᵢ is equal to the critical angle θ_{c}.

Now, we can solve for θᵢ, and we get the equation for the critical angle:

$${θ}_{c} = {θ}_{i} = arcsin ( \frac{{n}_{2}}{{n}_{1}} ) ,$$

If the incident ray is precisely at the critical angle, the refracted ray is tangent to the boundary at the point of incidence. If for example, visible light were traveling through acrylic glass (with an index of refraction of 1.50) into air (with an index of refraction of 1.00), the calculation would give the critical angle for light from acrylic into air, which is

$${θ}_{c} = arcsin ( \frac{1.00}{1.50} ) = 41.8 ° .$$

Light incident on the border with an angle less than 41.8° would be partially transmitted, while light incident on the border at larger angles with respect to normal would be totally internally reflected.

If the fraction n₂/n₁ is greater than 1, then arcsine is not defined—meaning that total internal reflection does not occur even at very shallow or grazing incident angles. So the critical angle is only defined when n₂/n₁ is less than 1.

An important side effect of total internal reflection is the propagation of an evanescent wave across the boundary surface. Essentially, even though the entire incident wave is reflected back into the originating medium, there is some penetration into the second medium at the boundary

This wave in the optically less dense medium is known as the evanescent wave. It's characterized by its propagation in the x direction and its exponential attenuation in the z direction. Although there is a field in the second medium, it can be shown that no energy flows across the boundary.

Under “ordinary conditions” it is true that the creation of an evanescent wave does not affect the conservation of energy, i.e. the evanescent wave transmits zero net energy. However, if a third medium with a higher refractive index than the low-index second medium is placed close to (within less than several wavelengths distance from) the interface between the first medium and the second medium, the evanescent wave will be different from the one under “ordinary conditions” and it will pass energy across the second into the third medium. This process is called “frustrated” total internal reflection (FTIR) and is very similar to quantum tunneling. The quantum tunneling model is mathematically analogous if one thinks of the electromagnetic field as being the wave function of the photon. The low index medium can be thought of as a potential barrier through which photons can tunnel.

The transmission coefficient for FTIR is highly sensitive to the spacing between the high index media (the function is approximately exponential until the gap is almost closed), so this effect has often been used to modulate optical transmission and reflection with a large dynamic range such as optical fingerprint imaging.

Most fingerprint sensors use FTIR to improve the image by directing an illuminating source at the surface of the sensor such that the light strikes the window to air interface at an angle greater than the critical angle causing TIR. The surface of the window is imaged through the window so that the reflected light from the surface is captured as an image. Ridges contacting or within a few hundred nanometers of the surface of the window will result in FTIR causing a dark image of the ridges to appear. For devices like these, the light source and image capture devices are separated.

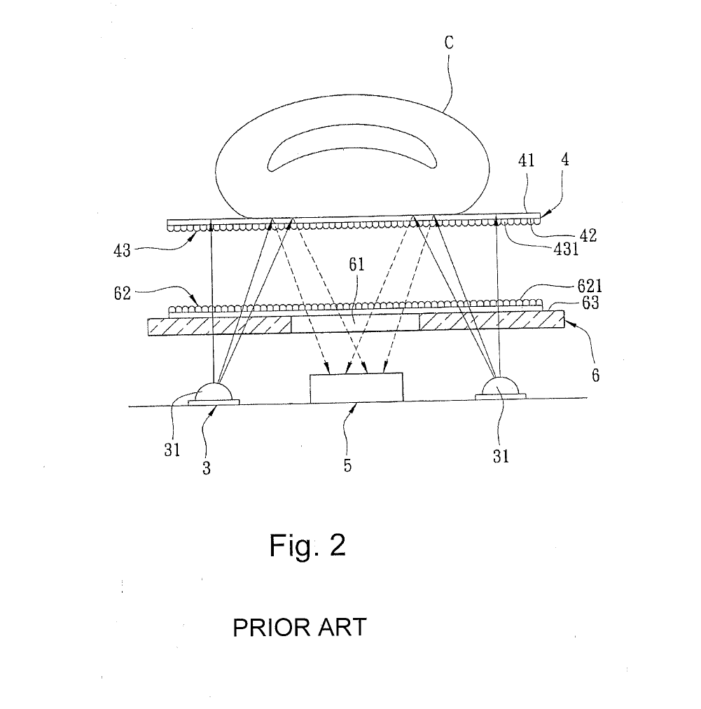

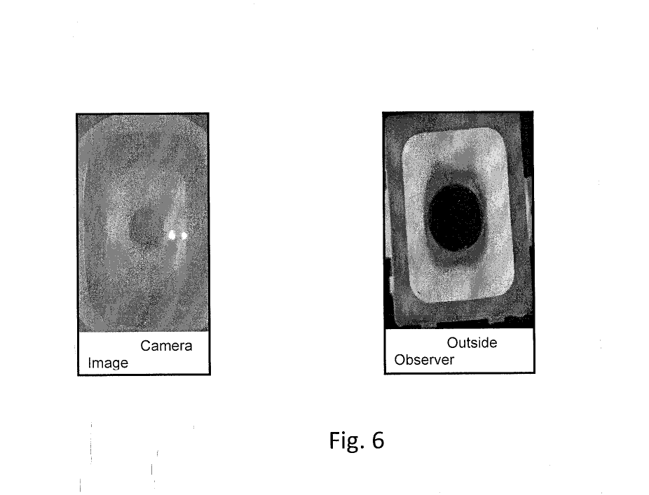

U.S. Pat. No. 8,204,284 to Wu hereby incorporated by reference shows in FIG. 6 thereof a fingerprint identifying system. FIG. 6 of the Wu patent has been included herein as FIG. 2. The patent describes a method for effectively combining the illumination source with the image allowing significant reduction in the optical path necessary to create the image, with the advantage of reducing the size of the sensor.

In FIG. 2 light from the light source (in this case LED emitters, 31) is scattered by a diffusing device (62) to uniformly illuminate the bottom of the finger press plate (4). This diffusing device has a hole in the center (61) to allow the camera (5) to view the bottom of the press plate (43). The bottom of the press plate has a diffusing surface (43) that further scatters the light in random directions within the press plate. Light that is scattered in a direction so that the angle at which it contacts the top surface of the press plate (where the finger is contacting the press plate, 41) that is greater than the critical angle is totally reflected back onto the diffusing surface (43) and further scattered. Due to FTIR from the ridges, the intensity of light striking the diffusing surface (43) from above varies according to the pattern of ridges in the finger, creating an image of the fingerprint pattern on the diffusing surface that can be captured by a camera (5).

Not shown in the FIG. 2 is a clear window that, while not necessary for the operation of the technology described in the Wu invention, is useful for a practical device. This is because the fidelity of the fingerprint image depends on the thickness of the press plate (4). Light reflecting off of the upper surface and illuminating the lower surface produces an image the intensity of which is the total of the light that was reflected from the entire upper surface. The most intense light is that coming from immediately above the point, but light further away does contribute to the image. As a result, the image is best reproduced when the press plate has zero thickness, and the fidelity degrades with increasing thickness.

In practice the thickness of the press plate is approximately 25 microns thick. To support a typical user pressing a finger onto the press plate, a material must be chosen that is both optically clear and is relatively high strength. In practice these materials may be difficult to use and/or expensive. Another option to support the press plate when a finger is pressing on it is to position a more substantial clear support window between the diffuser (62) and the press plate (4). Typically the thickness of the window is on the order of ½ mm to 1 mm.

The support window used in all practical implementations has been carefully chosen to be optically clear and structurally sound. At least two high clarity materials have been used in development and in production—glass and polycarbonate.

These materials were chosen to be strong enough to support several pounds of finger pressure and transmit the most light to brightly illuminate the finger and allow the clearest image to return to the camera.

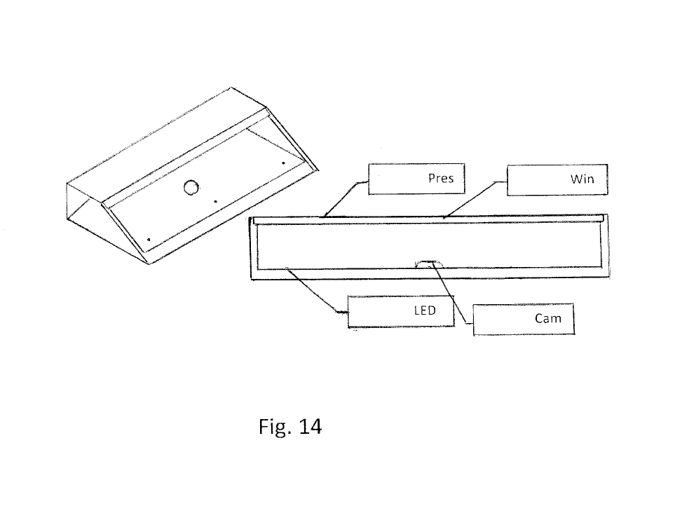

FIG. 14 shows a cut-away view of an example assembly with the window placed just below the thin press plate. Implementation examples of the Wu invention have been created both with and without the support window. In general, the implementations using the support window have been more successful. The only known device currently in production uses the structural advantage of the support window.

Various implementations of the Wu patent have been tested in order to improve the function of the biometric device. The metrics typically are measured as a frequency of false-positive readings, false-negative readings, or some combined error rate. Of particular interest is the error rate incurred when the user has a “dry-finger” condition.

The dry-finger condition is a common challenge for all fingerprint sensing devices. When a finger is dry and cold, the ridges of the fingerprint do not conform as easily and they have less interaction with the surface. Consequently the effects of TIR and FTIR are reduced in optical sensors, and the reduced effects result in less optical contrast between the ridges and the valleys of the fingerprint.

The performance of the distributed light sensor has been steadily improved by working with both the optical hardware and the firmware/software. The firmware/software improvements are not immediately relevant, but the improvements made to the optical hardware and light distribution are relevant.

All implementations of fingerprint sensors using the distributed light model described Wu patent suffer from non-uniform light distribution across the fingerprint image collected by the camera. Of particular interest are the dark circle in the center that is a result of the presence of the camera in the center of the base surrounded by light sources, and the bright areas around the center as a result of the light sources.

Much attention has been paid to evenly distribute the light and reduce the non-uniformity observed by looking at the press plate and also seen in the images captured by the camera.

To mitigate the negative effects of the non-uniform illumination and visible artifacts, the developers discovered several methods to improve the illumination and minimize the artifacts. Significant improvements to both the observed and the captured image were made by working with multiple light sources and diffusion plates to the assembly. The side walls of the cavity are also important to the image quality and stability.

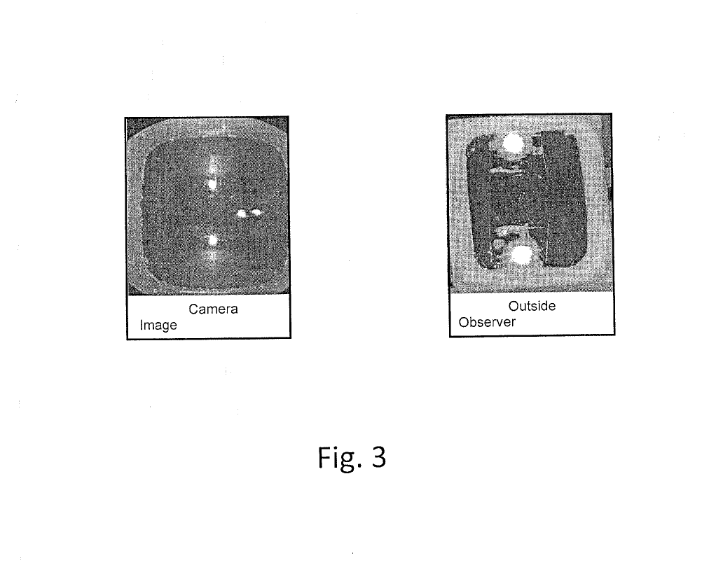

Several generations of development as shown in the pictures of FIGS. 3-8 have continually improved these issues and lead to the working sensor that is currently in production.

The original minimal configuration with two light sources is shown in FIG. 3. Note the bright spots near the light sources and the dark hole in the middle of the sensor. These features are consistently visible in the internal camera image with and without a fingerprint, and also from an outside observer.

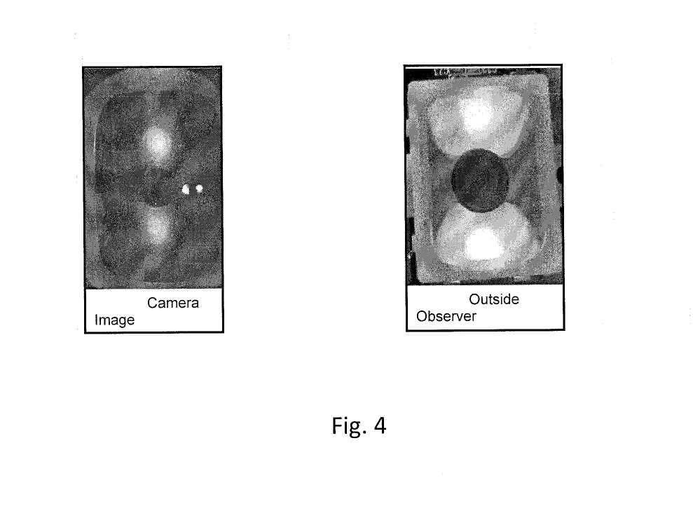

The addition of a diffusion plate between the LEDs and the sensor provides another significant improvement to the light distribution. Because the plate redirects the light to a random orientation, more light is incident on the press plate at angles above the critical angle necessary for TIR—this theoretically improves the contrast of the print image. The highlights are still visible, but less harsh. The dark hole is still highly visible see FIG. 4.

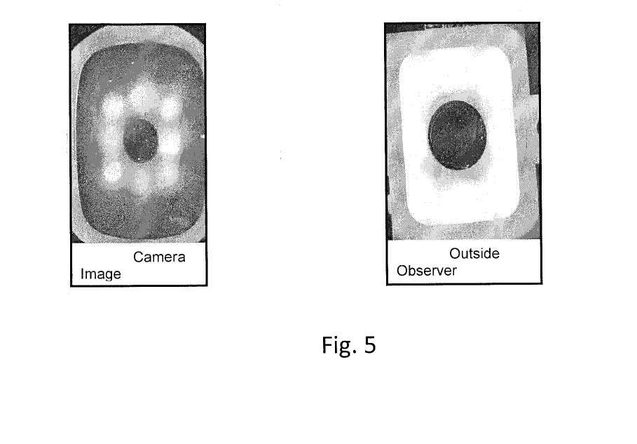

Multiple light sources significantly improve the light distribution so the illumination is more uniformly spread around the sensor. However, the intense highlights and the dark circle remain highly visible in all views see FIG. 5.

Adding a second base plate and selecting both plates to be highly transmissive and orthogonally oriented further increases the uniformity of the illumination and directs more light at high angles for TIR to promote higher contrast. However, the light distribution across the press plate shows distinct regions of light and dark in all views see FIG. 6.

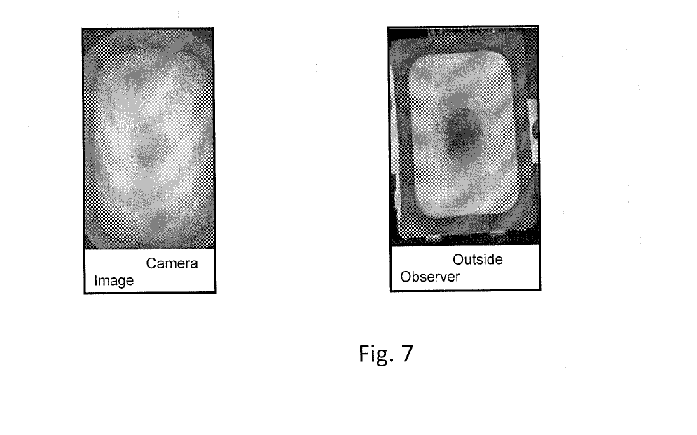

Addition of the 3^{rd} diffusion film to the top surface of the press plate improves the apparent quality by obscuring the internal mechanisms as well as softening the harshness of the light sources from the outside observer. The 3^{rd} film layer also redirects incoming light randomly and increases the TIR condition for higher contrast as shown in FIG. 7.

However, all views continue to show highly significant non-uniform illumination and the persistent “hole” in the center of the field of view.

The current model has been tested with an acceptable EER of less than 2%. However, an EER well below 1% is necessary to open the market for maximum value applications. Achieving sub-1% EER requires a clear image—uniform illumination with minimal visual artifacts.

In addition to achieving the technical goals, the typical developers of high-end systems expect “clean” images of the fingerprint and are reluctant to accept a sensor with a “cluttered” print image.

Technically they are an obstacle because simple image enhancement also tends to enhance the artifacts and obfuscate the extraction and matching. Aesthetically, the unwanted optical effects are as prominent to a viewer as the fingerprint itself, and are distracting.

In parallel with the illumination improvements, there has been significant effort made to improve the dry-finger performance. This includes testing a variety of contact materials including mylar, polyimide, glass, acrylic, silicone, etc. Silicon is particularly promising because it is known to improve the dry-finger performance in commercially available prismatic optical sensors.

Further attempts to improve the sensor with light sources changes, better coatings, increased diffusion, and careful attention to the enclosure have not been successful.

The non-uniform light distribution is prominent from observers both outside the sensor looking at the press plate and as seen in the images captured by the camera.

These highly visible non-uniformities in the illumination continue to introduce variability in fingerprint recognition, create a negative response in the market, and frustrate attempts by the developers to mitigate the incomplete diffusion and non-random illumination.

Some non-uniformity was accepted as a characteristic of the overall design as a tradeoff to get the size advantage. Most optical scanners use a prism and TIR effects to create high contrast images. The prism-based construction also has the advantage of separating the camera and the light source so that the camera element is not in its own field of view. However, the thickness of the prism system because of the practical constraints of the prism is a disadvantage for some applications such as portable electronics.

For the optical diffusion sensor, it was expected there would be some level of light non-uniformity and artifacts compared to the prism-based system. The challenge for the developers was to maximize the diffusion in order to best “cover-up” the dark area that cannot be illuminated directly because the camera must exist there.

The prominence of the artifacts and non-uniformity and the benefits of TIR effects has previously focused all attention of the developers (including the authors) on increasing the diffusion of the source light. Continuous improvements of this nature yielded steadily improved image and fingerprint quality. This reinforced the common understanding among the developers that if the uniformity can be perfected, the image would be optimized.

The string of successes, the exhaustive testing, the prominence of the artifacts, and the common perception that some artifacts are likely to be present in the end, all combined to confirm that everything reasonable has been done with the optical system.

Further improvements can be made by digital image processing to attempt to selectively enhance the darker regions and reduce or subtract out the artifacts. Digital Image processing is effective; however digital image processing requires additional energy and can result in longer processing time, require more expensive electronics, and consume more power—all which have negative effects on overall system cost and usability. Additionally, all image processing done to normalize the image is likely to add or subtract biometric information from the image in non-uniform ways. It can make the image appear better and enhance the gain of the signal, but digital image processing cannot fundamentally alter the basic signal-to-noise ratio in the analog image.

If the original analog image (signal) is significantly occluded by artifacts and non-uniform illumination (noise), then it may be impractical for the image processing system to extract a clear fingerprint. It is especially challenging in this application because the image processing should not use heuristics to artificially enhance the signal because any artificial pattern enhancement may alter the fundamental structure of the fingerprint. That is, the digital imaging processing can surely create a clean fingerprint, but it may not be the same as the fingerprint of the user.

In order for the Wu invention to be useful across all biometric applications, it is necessary to further improve the clarity of the analog image and increase the signal-to-noise ratio of the fingerprint.

This invention describes methods of improving both the quality and the integrity of the image. These improvements lead directly to improved ability of the sensor to accurately detect fingerprints under all conditions, including dry-finger conditions.

As described in the history, the problem with the commercial implementation of the sensor is the persistent existence of the non-uniform illumination and the visual artifacts in the field of view. These non-uniformities have persisted through sequential attempts to randomly distribute the light from discrete sources.

Careful testing and theoretical analysis of the system as well as the isolated components of the optical pathway suggested to the inventors that some of the issues may be coming from a previously unsuspected source. The support window may be contributing to the non-uniformity in an unexpected way.

This window degrades the image captured by the camera by creating spurious images by reflecting the image of the light source which is combined with the image of the fingerprint. Depending on the angle of the reflected light, the intensity of the reflected image may be even greater than the image of the fingerprint causing a severe signal to noise ratio problem that is difficult to remove by subsequent digital image analysis.

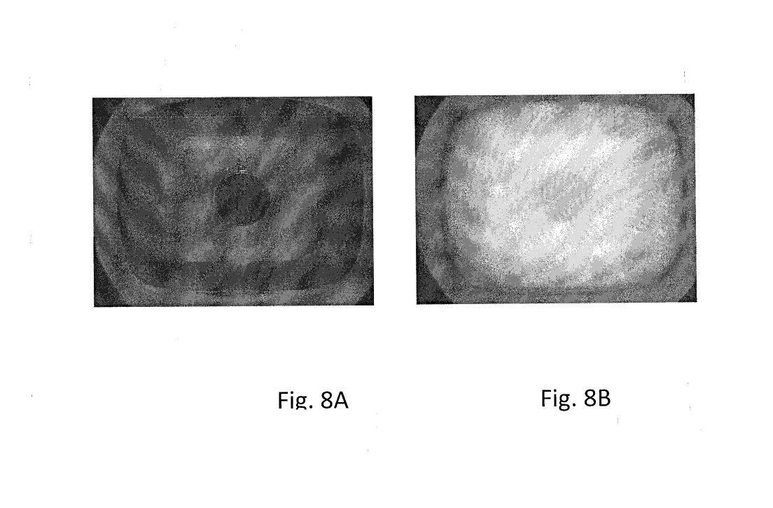

The picture in FIG. 8A shows the image captured by the camera when imaging only the clear window. The bright image in the center with the dark center disk is the reflected image of the illuminating diffuser. The picture in FIG. 8B is the image captured by the camera with the press plate in place and a finger pressed against the press plate. Most of the dynamic range of the camera is taken up by the difference in intensity between the dark spot in the middle of the image versus the bright reflection of the illuminating diffuser. When the reflected image is subtracted out the remaining image of the fingerprint has a much reduced dynamic range reducing the accuracy of the fingerprint evaluation.

What is needed is a method to reduce or eliminate the image of the illuminating diffuser that is reflected from the front and back surface of the window.

An antireflective or anti-reflection (AR) coating is a type of optical coating applied to the surface of lenses and other optical devices to reduce reflection. This improves the efficiency of the system since less light is lost. In complex systems such as a telescope, the reduction in reflections also improves the contrast of the image by elimination of stray light. In other applications, the primary benefit is the elimination of the reflection itself, such as a coating on eyeglass lenses that makes the eyes of the wearer more visible to others, or a coating to reduce the glint from a covert viewer's binoculars or telescopic sight. Or, in our case, the primary benefit is to reduce the reflected image of the illuminating diffuser from the window.

There are two separate causes of optical effects due to coatings, often called thick film and thin film effects. Thick film effects arise because of the difference in the index of refraction between the layers above and below the coating (or film); in the simplest case, these three layers are the air, the coating, and the glass. Thick film coatings do not depend on how thick the coating is, so long as the coating is much thicker than a wavelength of light. Thin film effects arise when the thickness of the coating is approximately the same as a quarter or a half a wavelength of light. In this case, the reflections of a steady source of light can be made to add destructively, and hence reduce reflections by a separate mechanism. In addition to depending very much on the thickness of the film, and the wavelength of light, thin film coatings depend on the angle at which the light strikes the coated surface.

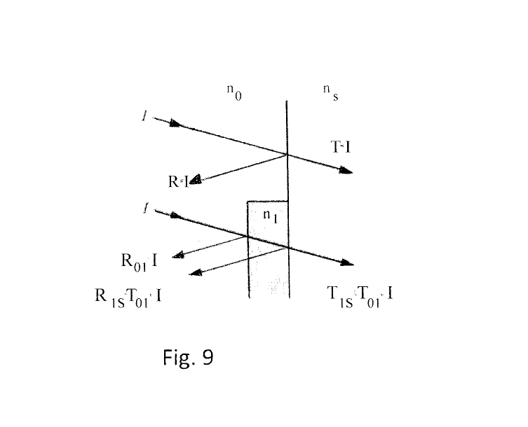

Whenever a ray of light moves from one medium to another (for example, when light enters a sheet of glass after travelling through air) some portion of the light is reflected from the surface (known as the interface) between the two media (See FIG. 9). This can be observed when looking through a window, for instance, where a (weak) reflection from the front and back surfaces of the window glass can be seen. The strength of the reflection depends on the refractive indices of the two media as well as the angle of the surface to the beam of light. The exact value can be calculated using the Fresnel equations.

When the light meets the interface at normal incidence (perpendicularly to the surface), the intensity of light reflected is given by the reflection coefficient or reflectance, R:

$$R = {( \frac{{n}_{0} - {n}_{S}}{{n}_{0} + {n}_{S}} )}^{2} ,$$

where n₀ and n_{S} are the refractive indices of the first and second media, respectively. The value of R varies from 0 (no reflection) to 1 (all light reflected) and is usually quoted as a percentage. Complementary to R is the transmission coefficient or transmittance, T. If absorption and scattering are neglected, then the value T is always 1−R. Thus if a beam of light with intensity I is incident on the surface, a beam of intensity RI is reflected, and a beam with intensity TI is transmitted into the medium.

For the simplified scenario of visible light travelling from air (n₀=1.0) into common glass (n_{S}≈1.5) value of R is 0.04, or 4% on a single reflection. So at most 96% of the light (T=1−R=0.96) actually enters the glass, and the rest is reflected from the surface. The amount of light reflected is known as the reflection loss.

In the more complicated scenario of multiple reflections, say with light travelling through a window, light is reflected both when going from air to glass and at the other side of the window when going from glass back to air. The size of the loss is the same in both cases. Light also may bounce from one surface to another multiple times, being partially reflected and partially transmitted each time it does so. In all, the combined reflection coefficient is given by 2R/(1+R). For glass in air, this is about 7.7%.

First observed by Lord Rayleigh, a thin film (such as tarnish) on the surface of glass can reduce the reflectivity. This effect can be explained by envisioning a thin layer of material with refractive index n₁ between the air (index n₀) and the glass (index n_{S}). The light ray now reflects twice: once from the surface between air and the thin layer, and once from the layer-to-glass interface.

From the equation above, and the known refractive indices, reflectivities for both interfaces can be calculated, and denoted R₀₁ and R_{1S}, respectively. The transmission at each interface is therefore T₀₁=1−R₀₁ and T_{1S}=1−R_{1S}. The total transmittance into the glass is thus T_{1S}T₀₁. Calculating this value for various values of n₁, it can be found that at one particular value of optimum refractive index of the layer, the transmittance of both interfaces is equal, and this corresponds to the maximum total transmittance into the glass.

This optimum value is given by the geometric mean of the two surrounding indices:

n₁=\sqrt{n₀n_{S}}.

For the example of glass (n_{S}≈1.5) in air (n₀≈1.0), this optimum refractive index is n₁≈1.225.

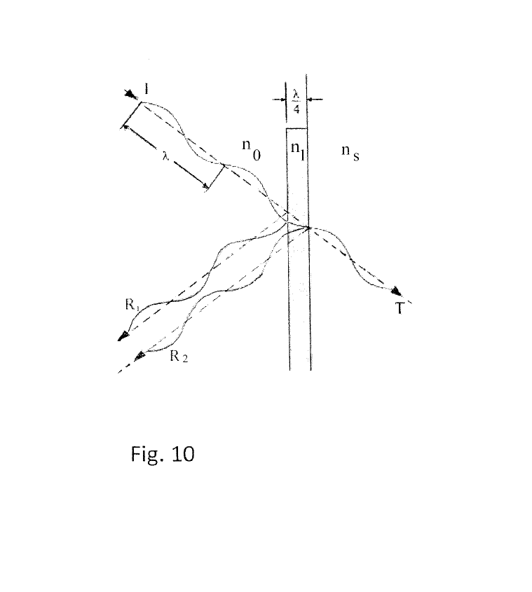

The reflection loss of each interface is approximately 1.0% (with a combined loss of 2.0%), and an overall transmission T_{1S}T₀₁ of approximately 98%. Therefore an intermediate coating between the air and glass can halve the reflection loss (See FIG. 10).

Further reduced reflection could in theory be made by extending the process to several layers of material, gradually blending the refractive index of each layer between the index of the air and the index of the substrate. Practical anti-reflection coatings, however, rely on an intermediate layer not only for its direct reduction of reflection coefficient, but also use the interference effect of a thin layer. Assume the layer's thickness is controlled precisely, such that it is exactly one quarter of the wavelength of light in the layer (λ/4=λ₀/(4n₁), where λ₀ is the vacuum wavelength). The layer is then called a quarter-ware coating. For this type of coating a normally incident beam I, when reflected from the second interface, will travel exactly half its own wavelength further than the beam reflected from the first surface, leading to destructive interference. This is also true for thicker coating layers (3λ/4, 5λ/4, etc.), however the anti-reflective performance is worse in this case due to the stronger dependence of the reflectance on wavelength and the angle of incidence.

If the intensities of the two beams R₁ and R₂ are exactly equal, they will destructively interfere and cancel each other since they are exactly out of phase. Therefore, there is no reflection from the surface, and all the energy of the beam must be in the transmitted ray, T. In the calculation of the reflection from a stack of layers, the transfer-matrix method can be used.

Real coatings do not reach perfect performance, though they are capable of reducing a surface's reflection coefficient to less than 0.1%. Also, the layer will be the ideal thickness for only one distinct wavelength of light. Other difficulties include finding suitable materials for use on ordinary glass, since few useful substances have the required refractive index (n≈1.23) which will make both reflected rays exactly equal in intensity. Magnesium fluoride (MgF₂) is often used, since this is hard-wearing and can be easily applied to substrates using physical vapor deposition, even though its index is higher than desirable (n=1.38).

Further reduction is possible by using multiple coating layers, designed such that reflections from the surfaces undergo maximum destructive interference. One way to do this is to add a second quarter-wave thick higher-index layer between the low-index layer and the substrate. The reflection from all three interfaces produces destructive interference and anti-reflection. Other techniques use varying thicknesses of the coatings. By using two or more layers, each of a material chosen to give the best possible match of the desired refractive index and dispersion, broadband anti-reflection coatings which cover the visible range (400-700 nm) with maximum reflectivities of less than 0.5% are commonly achievable.

The exact nature of the coating determines the appearance of the coated optic; common AR coatings on eyeglasses and photographic lenses often look somewhat bluish (since they reflect slightly more blue light than other visible wavelengths), though green and pink-tinged coatings are also used.

If the coated optic is used at non-normal incidence (that is, with light rays not perpendicular to the surface), the anti-reflection capabilities are degraded somewhat. This occurs because the phase accumulated in the layer relative to the phase of the light immediately rejected decreases as the angle increases from normal. This is counterintuitive, since the ray experiences a greater total phase shift in the layer than for normal incidence. This paradox is resolved by noting that the ray will exit the layer spatially offset from where it entered, and will interfere with reflections from incoming rays that had to travel further (thus accumulating more phase of their own) to arrive at the interface. The net effect is that the relative phase is actually reduced, shifting the coating, such that the anti-reflection band of the coating tends to move to shorter wavelengths as the optic is tilted. Non-normal incidence angles also usually cause the reflection to be polarization dependent.

Reflection can be reduced by texturing the surface with 3D structures (such as pyramids) or 2D grooves (gratings).

If wavelength is greater than the texture size, the texture behaves like a gradient index film with reduced reflection. To calculate reflection in this case effective medium approximations can be used. To minimize reflection various profiles of pyramids have been proposed, such as cubic, quintic or integral exponential profiles. Commercial materials using particles that are a few hundred nanometers in size are available as anti-reflection films that can be applied to windows to reduce reflections.

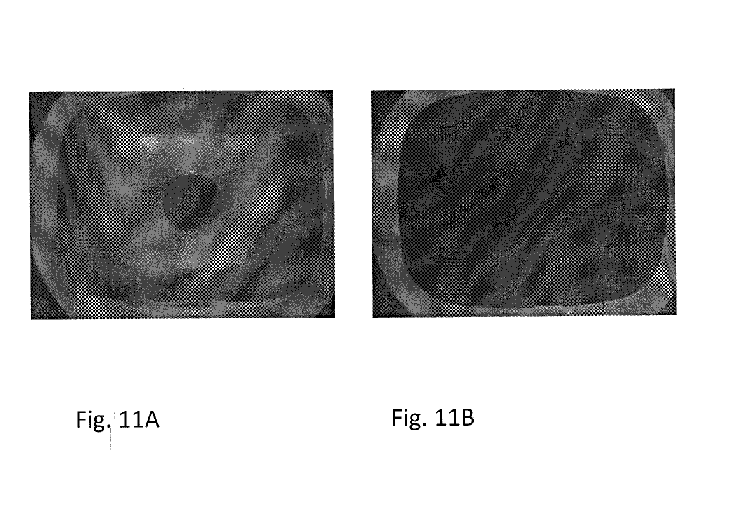

Significant improvement in the fingerprint image can be achieved by reducing or eliminating the reflected image of the illuminating diffuser from the clear window. FIGS. 11A & 11B show the difference that an AR coating makes in the reflected image from the window of a fingerprint sensor.

The picture in FIG. 11A shows the reflected image captured by the camera from an untreated window. The picture in FIG. 11B is the image captured by the camera of a window with a commercial AR coating applied to both sides of the window.

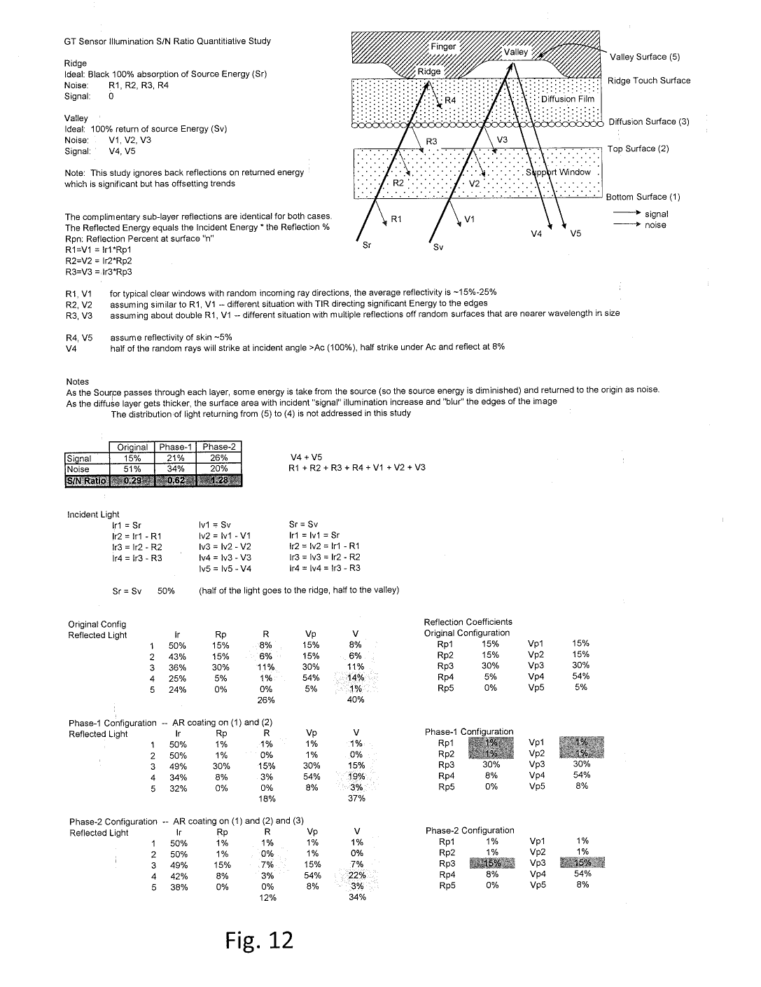

FIG. 12 shows an Excel spreadsheet showing an estimate of the effect that AR coatings on different surfaces of the structure will have on the signal to noise ratio (S/N). For an AR coating on both sides of the window only, the SN ratio increases by about 50% from 0.29 to 0.62. Adding an AR coating to the diffusing side of the press plate further increases the SN ratio to 1.28, over double the SN ratio of the original window.

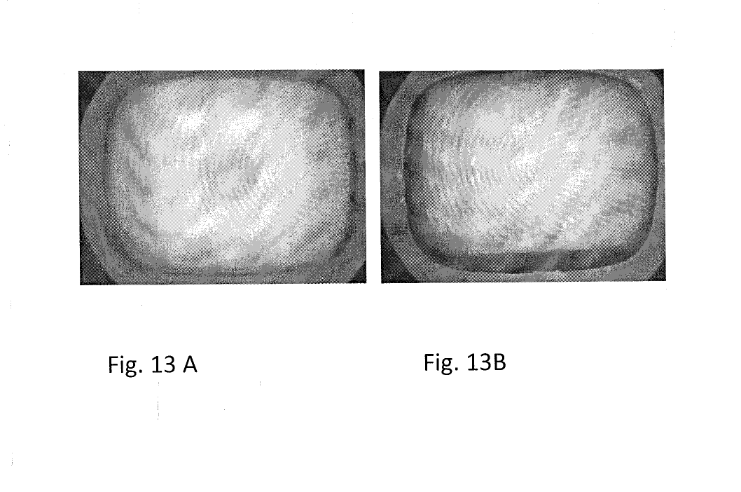

FIGS. 13A & 13B show the practical effect of increasing the SN ratio from 0.29 to 0.62 by adding an AR coating to both sides of the window.

The picture in FIG. 13A shows the image captured by the camera of the bottom of the press plate with the original window (SN ratio=0.29). The picture in FIG. 13B shows the image captured by the camera of the bottom of the press plate using a window with an AR coating on both sides (SN ratio=0.62).

The picture in FIG. 13A will be difficult to analyze digitally because of the varying intensity caused by the reflected image. In the picture in FIG. 13B the reflected image has been removed prior to capture by the camera so that the image can be digitally analyzed to increase contrast between the ridges and the valleys of the fingerprint.

Following this chain of thought, there is another opportunity to decrease the noise in the final image and increase the S/N ratio by reducing the reflection from the touch plate diffusion layer. In practical applications, the diffusion surface of the press plate reflects a great deal of incident light. The light is reflected randomly, but the high reflectivity of the film creates a significant overall noise component back to the camera. Selecting or modifying the diffusion film to achieve low back-reflection can increase the S/N ratio up to 50% more.

We claim:

1. A fingerprint sensor comprising:
a diffusion film;
a light source and camera;
a support window positioned between the diffusion film and the light source and camera; and
an AR coating upon surfaces of the diffusion film and/or the support window.

2. The fingerprint sensor of claim 1, wherein the AR coating is upon both the diffusion film and the support window.
